(19) United States
(12) Patent Application Publication
(10) Pub. No.: US 2016/0239752 A1
(43) Pub. Date: Aug. 18, 2016

(54) INCIDENT RECONSTRUCTIONS USING TEMPORAL AND GEOGRAPHIC ANALYSIS

(71) Applicants: Mengjiao Wang, Shanghai (CN); Wen-Syan Li, Shanghai (CN)

(72) Inventors: Mengjiao Wang, Shanghai (CN); Wen-Syan Li, Shanghai (CN)

(21) Appl. No.: 14/624,246

(22) Filed: Feb. 17, 2015

(51) Int. Cl. G06N 7/00; G06F 17/30

(52) U.S. Cl. CPC G06N 7/005; G06F 17/30044; G06F 17/30041

(57) ABSTRACT

An incident handler receives a plurality of incident reports, each incident report characterizing an incident occurring within a geographical area. An incident model generator generates an incident model, based on, for each incident, an occurrence time window and an occurrence area within the geographical area. An incident estimator receives a new incident report characterizing a new incident occurring within the geographical area and recorded within a plurality of media files captured by at least one media capture device, the new incident report including a new occurrence time window and new occurrence area. The incident estimator further prioritizes the plurality of media files, based on the incident model, the new occurrence time window, and the new occurrence area, in an order corresponding to a likelihood of inclusion of the new incident therein. A media manager selects and sorts the prioritized media files for ordered playback thereof.

### TECHNICAL FIELD

This description relates to identifying recorded incidents.

### BACKGROUND

Cameras and other media capture devices are often used as part of an overall surveillance system(s) to capture video, audio, or other data related to incidents which occur in a vicinity of such devices. For example, a municipal police department may deploy cameras throughout a city, in order to monitor residents and reduce incidences of crime. Similarly, a private enterprise may deploy cameras for related purposes, such as when cameras are deployed throughout a retail store, in order to identify shoplifters.

It is possible to deploy these and other types of monitoring systems and associated surveillance devices on a large scale, and to thereby capture a large quantity of monitoring data. For example, in the examples just mentioned, a large number of video files may be captured by the police department or private enterprise. The video files may include video captured over a window of time, and across a potentially large geographic area(s).

Consequently, the video files themselves may be large and/or numerous. In order to use the video files for their intended purpose (e.g., to identify a thief), it may be necessary for human users to review the video files to identify a particular face, stolen item, sound, and/or other video content. Given the potentially voluminous nature of the video or other media files, however, it may be inconvenient, impractical, or essentially impossible for a given quantity of human resources to review the media files accurately and completely within an available time limit.

### SUMMARY

The present description relates to techniques for prioritizing video or other media files, so that those that are most likely to include an incident being sought will be reviewed earlier than those files which are considered less likely to include the incident. More particularly, historical incidents are used to create an incident model, in which each historical incident is characterized at least by time and location of occurrence. Then, when a new incident is being investigated, the incident model is used to prioritize available media files, e.g., video files, which may contain a recording of the incident. In this way, a human or automated user reviewing the prioritized files in order of priority will be more likely to locate the recording of the incident quickly, and with a minimum of effort.

In more detail, the referenced incident model may be constructed by, e.g., identifying a time window of occurrence of each historical incident, along with a relevant geographical area in which the cameras or other media capture devices are deployed. Then, each time window is segmented into time segments, and, similarly, each geographic area is segmented or otherwise divided. Each temporal and geographic segment is weighted based on a likelihood of the incident having occurred therein. The incident model is then constructed based on the combined probability distribution for the temporal and geographic segments. When a new incident is being investigated, and is identified as having occurred within an associated time window and geographic area, the incident model may be used to create a sorted list, e.g., of video files, captured within various time segments of the associated time window and geographic segments of the associated geographic area.

According to one general aspect, a computer program product is tangibly embodied on a non-transitory computer-readable storage medium. The computer program product includes instructions that, when executed, are configured to cause at least one processor to receive a plurality of incident reports, each incident report characterizing an incident occurring within a geographical area, and generate an incident model, based on, for each incident, an occurrence time window and an occurrence area within the geographical area. The instructions, when executed, are further configured to cause the at least one processor to receive a new incident report characterizing a new incident occurring within the geographical area and recorded within a plurality of media files captured by at least one media capture device, and prioritize the plurality of media files, based on the incident model, in an order corresponding to a likelihood of inclusion of the new incident therein.

According to another general aspect, a computer-implemented method for executing instructions stored on a non-transitory computer readable storage medium includes receiving a plurality of incident reports, each incident report characterizing an incident occurring within a geographical area, and generating an incident model, based on, for each incident, an occurrence time window and an occurrence area within the geographical area, wherein the occurrence time window is defined as existing between a time from which a corresponding incident first may have happened, and a time at which the incident was ascertained to have actually happened, and wherein the occurrence area is defined as a portion of the geographic area including a route over which a moving object moved to travel from a start point to an end point of the occurrence area. The computer-implemented method further includes receiving a new incident report characterizing a new incident occurring within the geographical area and recorded within a plurality of media files captured by at least one media capture device, the new incident report including a new occurrence time window and new occurrence area, and prioritizing the plurality of media files, based on the incident model, the new occurrence time window, and the new occurrence area, in an order corresponding to a likelihood of inclusion of the new incident therein.

According to another general aspect, a system includes at least one processor, and instructions recorded on a non-transitory computer-readable medium, and executable by the at least one processor. The system includes an incident handler configured to cause the at least one processor to receive a plurality of incident reports, each incident report characterizing an incident occurring within a geographical area, and an incident model generator configured to cause the at least one processor to generate an incident model, based on, for each incident, an occurrence time window and an occurrence area within the geographical area. The system further includes an incident estimator configured to cause the at least one processor to receive a new incident report characterizing a new incident occurring within the geographical area and recorded within a plurality of media files captured by at least one media capture device, the new incident report including a new occurrence time window and new occurrence area. The incident estimator is further configured to cause the at least one processor to prioritize the plurality of media files, based on the incident model, the new occurrence time window, and the new occurrence area, in an order corresponding to a likelihood of inclusion of the new incident therein. A media manager is configured to cause the at least one processor to select and sort the prioritized media files for ordered playback thereof.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for incident search facilitation using a temporal and geographic analysis.

FIG. 2 is a flowchart illustrating example operations of the system of FIG. 1.

FIG. 3 is a block diagram of an example implementation of the system of FIG. 1.

FIG. 4 is a first simplified map illustrating a first example geographical area that may be analyzed using the systems of FIGS. 1 and 3.

FIG. 5 is a second simplified map illustrating a second example geographical area that may be analyzed using the systems of FIGS. 1 and 3.

FIG. 6 is a flowchart illustrating more detailed example operations of the systems of FIGS. 1 and 3.

### DETAILED DESCRIPTION

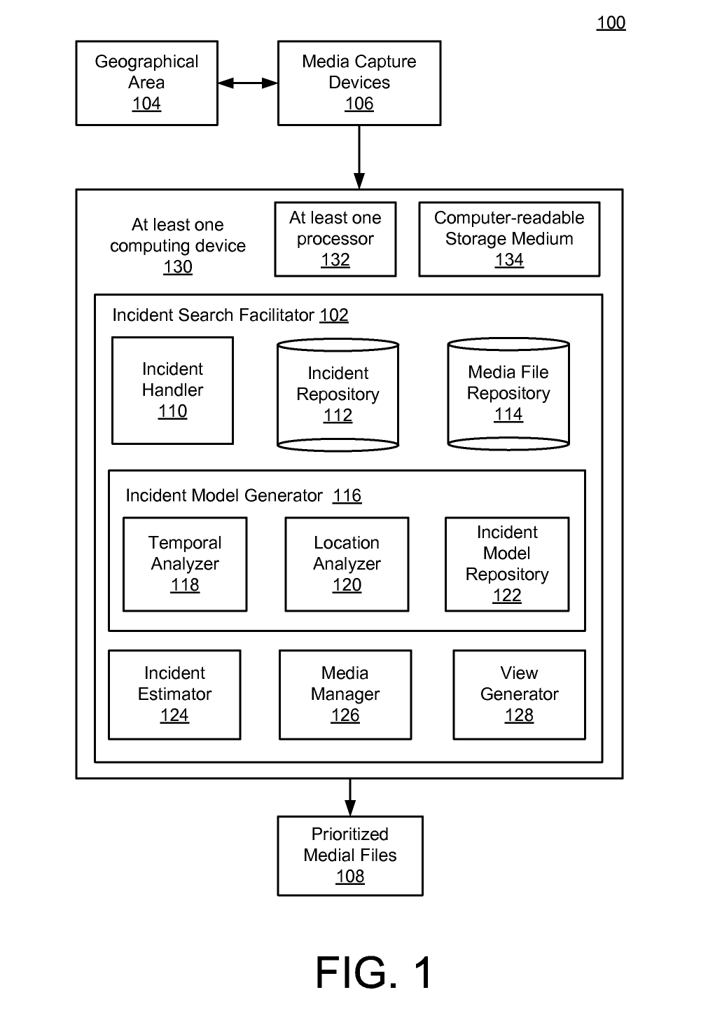

FIG. 1 is a block diagram of a system 100 for incident search facilitation using a temporal and geographic analysis. In the example of FIG. 1, an incident search facilitator 102 is configured to facilitate a search for an incident occurring within a geographical area 104, where it is assumed or believed that the incident was recorded or otherwise captured through the use of one or more media capture devices 106.

That is, the media capture devices 106, such as audio and/or video recording devices, are assumed or believed to have recorded various occurrences within the geographical area 104, and within a relevant time window, including an incident being sought. In common scenarios in which the media capture devices 106 have produced a large number of media files, such as audio and/or video files, the incident search facilitator 102 is configured to provide a plurality of prioritized media files 108. The prioritized media files 108 generally represent a subset of potentially relevant media files captured by the media capture devices 106, sorted and ordered according to a probability of containing a recording of a particular incident being sought. In this way, a user of the incident search facilitator 102 may be assisted in reviewing available, relevant media files, even in scenarios in which a number of media files to be searched is very large, and a likelihood of locating a particular incident in a fast, efficient, accurate, and convenient manner is increased.

In practice, the geographical area 104 should generally be understood to represent virtually any location, where the definition or boundaries of any such location may be set in any conventional or convenient manner. For example, the geographical area 104 may be as small as a single building, or smaller, or may be as large as an entire city, or larger. Thus, in the former case, the geographical area 104 may be defined by the structure of a particular building, including, e.g., walls, floors, hallways, elevators, stairwells, or rooms. In the latter case, the geographical area 104 may be defined by city boundaries, latitude/longitude/altitude data, or street names. Further, as described in detail below, the geographical area 104 may be divided into a number of sub-areas or segments, using appropriate characterizations thereof (e.g., floors/stairwells/hallways/rooms in the first example, or buildings/streets/intersections in the second example).

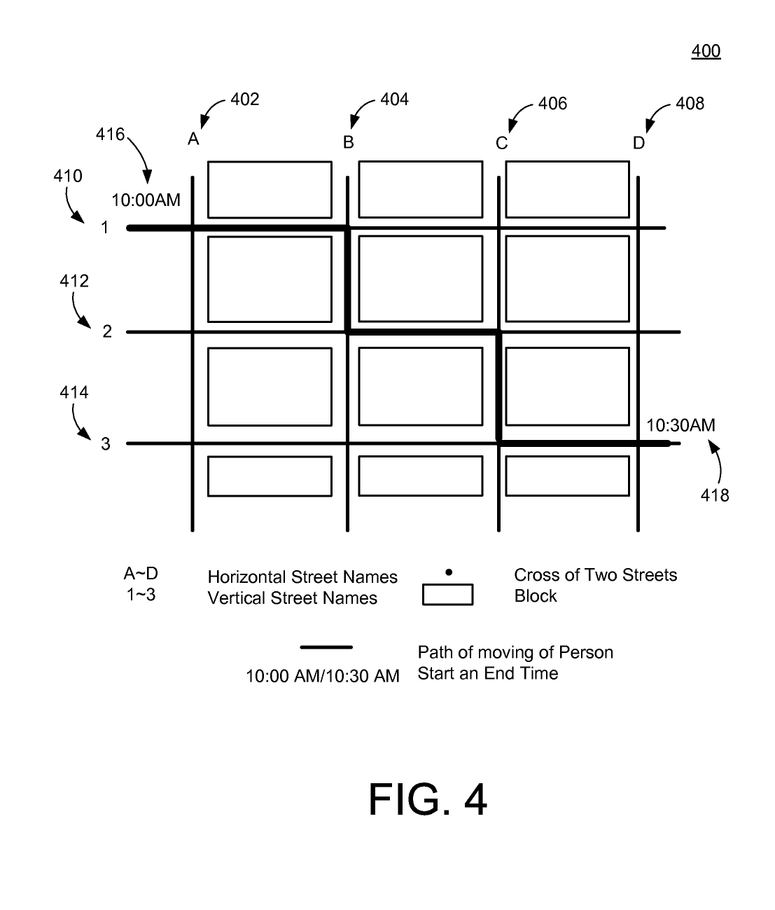

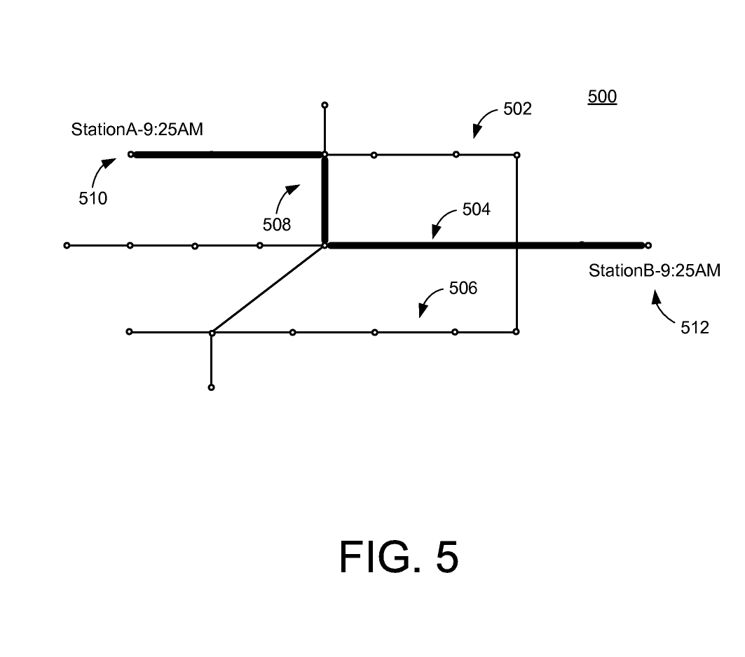

Example scenarios in which the geographical area 104 represents a part of a city are provided below, with respect to FIG. 4. Meanwhile, FIG. 5 provides an alternate example in which the geographical area 104 includes a portion of a subway system. Of course, again, such examples are non-limiting, and are not intended to be exhaustive. By way of further example, the geographical area 104 may represent a group of highways, railroads, or a body of water and associated shipping lanes.

In these and various other implementations, it is assumed that the media capture devices 106 are deployed within, or otherwise positioned to capture or record, the geographical area 104. In general, the media capture devices 106 may represent virtually any device operable to record or otherwise capture incidents or other occurrences occurring within the geographical area 104, and to output corresponding media files for storage and subsequent review by a user of the system 100.

In many of the examples in the following description, the media capture devices 106 are described as including video cameras configured to capture video and associated audio of events within the geographical area 104, for storage as corresponding audio/video files. Of course, such examples are not intended to be limiting, and the media capture devices 106 should be understood to represent or include, e.g., audio recording devices, still image recording devices, devices for recording a speed, size, or weight of an object, devices for recording seismic activity, devices for detecting indications of certain chemicals, biological agents, or radiation or virtually any other type of sensor operable to record digital media files containing information characterizing events transpiring within the geographical area 104.

In many cases, the media capture devices 106 may be deployed within the corresponding geographical area 104. For example, the media capture devices 106 may represent cameras positioned and installed at a plurality of defined locations within the geographical area 104. For example, cameras may be installed at various locations throughout a building, or along a plurality of streets (e.g., on adjacent buildings, on utility poles, or together with traffic lights). In many cases, the media capture devices 106 may be deployed based at least in part on a type and range of coverage provided by individual ones of the media capture devices 106. For example, cameras may be deployed at regular intervals along a city street, and at distances that minimize unnecessary or redundant overlap of coverage areas of the individual cameras. However, it is not required that the media capture devices 106 provide a complete coverage of all portions or sub-areas of the geographical area 104. For example, the media capture devices 106 may be positioned at locations within the geographical area 104 that have been determined to be most likely to capture incidents of interest. Thus, in some implementations, it will be appreciated that it may be practical or desirable to define the geographical area 104 in terms of a coverage area provided by the media capture devices 106.

In additional or alternative implementations, the media capture devices 106 need not be deployed directly within the geographical area 104, and may instead simply be positioned to provide coverage thereof from within an adjacent area. Further, the media capture devices 106 need not be installed at stationary positions, and may include mobile or moveable media capture devices, such as media capture devices deployed using satellite, drones or other manned or unmanned aerial vehicles, or automobiles or other land-based vehicles. Of course, the media capture devices 106 should also be understood to include any of the various combinations of the various types of media capture devices referenced above, and/or any of the described deployment methods, or variations thereof.

Given the wide-ranging nature of the geographical area 104, and of the media capture devices 106, as just described, it will be appreciated that the types of incidents and associated events or other occurrences within the geographical area 104 and captured by the media capture devices 106 may be similarly diverse. That is, the term incident, as used herein, should be understood to represent virtually any type of event or occurrence that has been recorded by one or more of the media capture devices 106 within the geographical area 104, and that may be of particular interest to a user of the system 100. Of course, the type of incident recorded will generally correspond to corresponding capabilities of the media capture devices 106 being used.

In many of the examples that follow, as referenced above, it is assumed that the media capture devices 106 include a plurality of video cameras. In many such examples, it may occur that the incidents of interest include illegal or other illicit activities, recordings of which might be sought by police or other security forces. However, even in the specific examples in which the media capture devices 106 are assumed to include video cameras, many other types of incidents may be investigated or analyzed, including, e.g., incidents involving accidents, customer behaviors, athletic performances, certain business activities (such as shipments/deliveries), or virtually any other type of activity of a human, animal, automated device, or natural occurrence (e.g., natural disaster) that may be recorded by video cameras or other types of the media capture devices 106. Even more generally, the incidents may be said to involve virtually any moving object (such as the examples just mentioned) that move, or are moved, in order to travel from a start point to an end point within the geographical area 104.

In many scenarios in which these various types of incidents that occur within the geographical area 104 are captured by the media capture devices 106, it may occur, as referenced above, that the media capture devices 106 ultimately output a large number of corresponding media files. For example, in many scenarios, the media capture devices 106 may be configured to record data in a continuous or semi-continuous manner, with the result being that many events or occurrences within the geographical area 104, and within a relevant time period, will be captured that are not of any particular interest to a user of the system 100. In other words, the media capture devices 106 may be deployed within the geographical area 104 based on an assumption that it is difficult or impossible to predict a time or location of the types of incident that are of interest to a user of the system 100, with the result being that is considered necessary to record virtually all events or occurrences that may possibly contain an incident of interest. As a result of this strategy, of course, a large number and percentage of media files provided by the media capture devices 106 will be of little or no interest to the user of the system 100 in identifying and analyzing a particular, desired incident.

Consequently, as referenced above, the incident search facilitator 102 is configured to characterize some or all of the media files received from the media capture devices 106, in order to provide the prioritized media files 108 as a group of sorted, ranked media files, and in an order or sequence that is determined by the sorting/ranking. In other words, the prioritized media files 108 are presented in sequence in which media files determined to be most likely to include an incident of interest will be provided earlier than media files considered to have a low probability of including a recording of the incident being sought. As a result, a user of the system 100 need not spend undue amounts of time searching through media files that do not contain the incident of interest. Instead, a likelihood is increased that the user of the system 100 will be able to locate the incident of interest within the prioritized media files 108 in a fast, efficient, accurate, and convenient manner.

In line with the above explanation and examples, and as described in detail below, the geographical area 104 may represent a city or other urban area, and the media capture devices 106 may include video cameras deployed by a local police force to record all available human activity, on the theory that such human activity will include various types of illegal or illicit behavior. Then, at a later time, upon a reporting of a specific incident of such illegal or illicit behavior, the local police force will be able to review captured video files in order to analyze the reported illegal/illicit incident, and ultimately identify and capture a perpetrator thereof. By way of even more specific example, a citizen may report a theft of a wallet or other valuable item during a pickpocketing incident that occurred within a certain time window within the geographical area 104, and the user of the system 100 may include a police officer or other authorized user who reviews the prioritized media files 108 in order to identify and arrest the relevant perpetrator in this example.

In the example of FIG. 1, the incident search facilitator 102 is illustrated as including an incident handler 110, which is configured to create and store a plurality of incident records within an incident repository 112. In other words, the incident repository 112 represents a historical database of incidents of interest that have previously occurred, e.g., within the geographical area 104. In some implementations, the incident handler 110 may receive such historical incidents directly from historical records, which may or may not have originally been captured by the media capture devices 106. For example, in the example scenarios just referenced in which the system 100 is operated by a police department, the police department may have various paper and electronic files characterizing various types of illegal or illicit incidents that previously occurred within the geographical area 104. Of course, in other cases, incidents handled by the incident handler 110 may in fact have been captured in the past by one or more of the media capture devices 106.

In operation, the incident handler 110 may receive data related to a specific incident, and may structure and store the data within the incident repository 112. For example, the incident handler 110 may identify a time window in which the incident being analyzed occurred. Similarly, the incident handler 110 may determine a geographical sub-area, segment, route, zone, or other occurrence area within the geographical area 104 in which the incident being analyzed occurred. In many of the following examples, it is assumed that a person (e.g., a crime victim) moves between a start point and end point of an occurrence area, but, as referenced above, the occurrence area may more generally be defined as any portion of the geographic area 104 including a route over which a moving object moves to travel from a start point to an end point of the occurrence area.

Of course, various other types of information may be included within an individual incident record being stored within the incident repository 112, including but not limited to a specific incident type of the incident being stored, identifying information related to the perpetrator of the incident being analyzed, other related circumstances of the incident, or virtually any other information that may be useful in identifying or resolving future incidents. Further details and examples regarding example implementations of the incident handler 110 and the incident repository 112 are provided in more detail, below.

Further in FIG. 1, a media file repository 114 represents a database or other repository for storing the various media files received from the media capture devices 106. In the specific examples provided below, such media files may include various video files, stored in any appropriate video file format. In some implementations, various ones of historical media files within the media file repository 114 may be utilized by the incident handler 110 in constructing corresponding incident records within the incident repository 112. Further, of course, the media file repository 114 may include a set of media files corresponding to an incident being sought, so that the prioritized media files 108 may represent an ordered set or subset of such potentially relevant media files.

An incident model generator 116 is configured to utilize relevant incident records of the incident repository 112, to thereby generate an incident model that is predictive with respect to a new incident that is currently being sought by a user of the system 100. More specifically, as described in detail below, the incident model generator 116 includes a temporal analyzer 118 that analyzes probabilities of occurrence of the incident being sought within a plurality of time segments of an occurrence time window in which the incident being sought occurred. Somewhat similarly, the incident model generator 116 also includes a location analyzer 120 that is configured to assign probabilities of occurrence of the incident being sought within a portion or sub-area of the geographical area 104. Then, by combining analysis results of the temporal analyzer 118 and the location analyzer 120, the incident model generator 116 generates one or more incident models for storage within an incident model repository 122, where the resulting incident model is thus predictive with respect to both a time and location of occurrence of the incident being sought.

Consequently, an incident estimator 124 may be configured to select and utilize a relevant incident model of the incident model repository 122, in order to quantify a corresponding probability distribution for the incident being sought. Based on the resulting estimation or prediction, the incident estimator 124 may be configured to order individual media files of the media file repository 114, beginning with the media file that is considered most likely to include a recording of the incident being sought. Then, a media manager 126 may be configured to receive the resulting media file rankings from the incident estimator 124, and may be further configured to access the media file repository 114 to retrieve the relevant media files in the indicated order.

A view generator 128 may thereafter be configured to receive the ranked media files from the media manager 126, and to display or otherwise output the prioritized media files 108, in order, for viewing or other consumption by the user of the system 100. In this way, as described herein, the user of the system 100 may consider the prioritized media files 108 in an order that increases a likelihood that the incident being sought will be found quickly and efficiently.

Of course, the system 100 of FIG. 1 represents a highly simplified view of example implementations of the incident search facilitator 102. For example, the system 100 of FIG. 1 illustrates at least one computing device 130 that includes at least one processor 132 and non-transitory computer readable storage medium 134. That is, the example of FIG. 1 generally illustrates that one or more computing devices, perhaps in communication with one another by way of an appropriate computer network, may include one or more processors, which may execute in parallel in order to support operations of the incident search facilitator 102. More specifically, one or more such processors may access and implement corresponding computer code or other instructions stored on the non-transitory computer readable storage medium 134, in order to thereby provide the incident search facilitator 102.

Of course, many other potential elements of the at least one computing device 130 are not explicitly illustrated in the example of FIG. 1, but would be apparent to one of skill in the art. For example, it will of course be appreciated that an appropriate display device may be utilized by the view generator 128, e.g., to provide the prioritized media files 108 for viewing or other consumption by the user of the system 100. Similarly, as referenced below, the view generator 128 may also provide a graphical user interface (GUI) or other interface by which a user of the system 100 may be enabled to operate the incident handler 110 (e.g., input historical incident records for storage in digital form, or parameterize operations of the incident handler 110 in analyzing historical media files from the media file repository 114 to thereby populate the incident records of the incident repository 112).

Further, although the incident search facilitator 102 is illustrated in FIG. 1 as a single element including various sub-elements 110-128, various embodiments may be implemented in which one or more of the various sub-elements 110-128 are implemented separately (e.g., on separate, communicating computing devices of the at least one computing device 130). For example, although the media file repository 114 is illustrated in FIG. 1 as part of the incident search facilitator 102, in various implementations, the media file repository 114 may be implemented and stored using otherwise conventional portions of a conventional incident capture system (e.g., surveillance system).

Somewhat similarly, although the various sub-elements 110-128 are illustrated and described as separate, discrete components, it will be appreciated that any one such component may be implemented as two or more sub-components. Conversely, in other implementations, it may occur that any two or more of the sub-elements 110-128 may be combined for implementation as a single sub-element of the incident search facilitator 102.

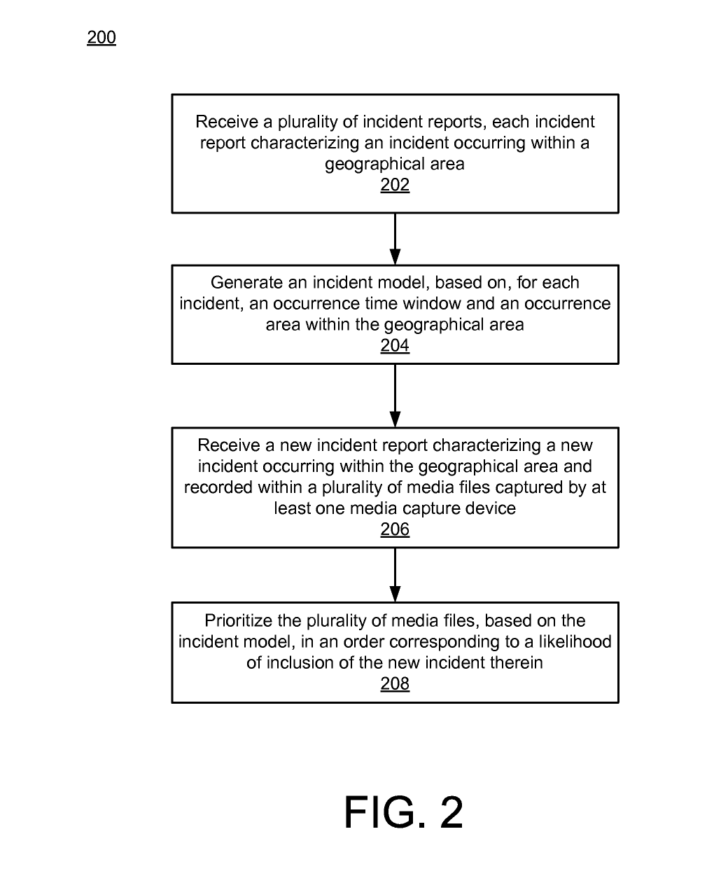

FIG. 2 is a flowchart 200 illustrating example operations of the system 100 of FIG. 1. In the example of FIG. 2, operations 202-208 are illustrated as separate, sequential operations. In various implementations, additional or alternative operations may be included, or one or more of the operations 202-208 may be omitted. In all such implementations, any two or more operations or sub-operations may be executed in a partially or completely overlapping or parallel manner, or in a nested, iterative, branched, or looped manner.

In the example of FIG. 2, a plurality of incident reports may be received, each incident report characterizing an incident occurring within a geographical area (202). For example, the incident handler 110, as described above, may receive a number of incident reports characterizing historical incidents that occurred within the geographical area 104. As described, the incident report may be received by the incident handler 110 by way of an appropriate user or application interface (e.g., as may be provided by the view generator 128). The incident reports may be obtained from legacy, historical incident records, and/or may be obtained through analysis of previous incidents recorded within various media files of the media file repository 114.

In some implementations, it may be desirable to include relevant incident reports for incidents that occurred outside of the specific geographical area 104, such as when, for example, the included incident reports occurred in geographical areas that share relevant characteristics of the geographical area 104. In any case, the various historical incident records may be formatted and stored as individual incident data records, or incident records, within the incident repository 112, using an appropriate data structure for each incident record. In particular, for example, each such incident record may include information regarding an occurrence time window in which the corresponding incident occurred, as well as a geographical portion (or sub-area, or segment) of the geographical area 104 in which the corresponding incident occurred. In general, the occurrence time window is defined as existing between a time from which a corresponding incident first may have happened (referred to below as a “from time”), and a time at which the incident was ascertained to have actually happened (referred to below as a “to time”).

An incident model may be generated, based on, for each incident, an occurrence time window and an occurrence area within the geographical area (204). For example, the incident model generator 116 of FIG. 1 may be configured to utilize the temporal analyzer 118 and the location analyzer 120 to generate and store one or more incident models within the incident model repository 122. More specifically, as referenced above and as described in more detail below, the plurality of incident records obtained from the incident repository 112 by the incident model generator 116 may share some common or relevant characteristics, such as a type of incident for which the incident model is being generated. As referenced in operation 204 of FIG. 2, each incident record of the group of incident records for which the incident model is being generated will include an occurrence time window in which the corresponding incident occurred, and/or an occurrence area representing a portion, sub-area, or segment of the geographical area 104 in which the corresponding incident occurred. Thus, a relative likelihood of occurrence of each incident of a group of incidents may be characterized with respect to both time and/or space, and a corresponding incident model for the entire group of characterized incident records may be generated, based on an aggregation or other combination of the individual temporal/geographical characterizations of each individual incident within the group of incidents.

A new incident report characterizing a new incident occurring within the geographical area and recorded within a plurality of media files captured by at least one media capture device may be received (206). For example, the incident estimator 124 of FIG. 1 may be configured to receive, perhaps by way of the incident handler 110 and the incident repository 112, a new incident data record characterizing a new incident to be analyzed. For example, as described in detail above with respect to FIG. 1, a user of the system 100 may wish to pinpoint a recording of a particular incident within a plurality of video files captured by video recorders of the media capture devices 106 configured to record all available events or occurrences within the geographical area 104, and within an available time period. More specifically, as may be appreciated from the examples above, the incident estimator 124 may be configured to select one or more appropriate, corresponding incident models from the incident model repository 122, and thereafter generate, in temporal and geographical terms, a prediction of a probability of occurrence of the new incident.

Then, the plurality of media files may be prioritized, based on the incident model, in an order corresponding to a likelihood of inclusion of the new incident therein (208). For example, the media manager 126 may receive the temporal/geographic predictions of the incident estimator 124, and may proceed to relate the temporal/geographic predictions to corresponding media files of the media file repository 114.

For example, the incident estimator 124 may predict, based on a relevant incident model, that the new incident being analyzed is most likely to have occurred within a first time segment, followed by a second time segment, followed by a third time segment. Similarly, the incident estimator 124 may predict relative likelihoods of occurrence of the new incident within a first street segment, a second street segment, and a third street segment (or within a first hallway, second hallway or a third hallway of a building, or other appropriate geographical occurrence area). Then the media manager 126 may be configured to identify three corresponding groups of media files from the media file repository 114, where the first retrieved group of media files would be recorded within the first time segment at the first location, the second retrieved group of media files recorded within the time segment at the second location, and the third retrieved group of media files was recorded within the third time segment at the third location. It may be necessary for the media manager 126 to correlate the received geographical segments within the geographical area 104 as being covered by corresponding ones of the media capture devices 106. In other words, for example, if the incident estimator 124 predicts occurrence of the new incident being analyzed at a certain likelihood within a particular street segment, then the media manager 126 may be configured to relate the identified street segment to one or more cameras positioned or otherwise deployed to record events occurring therein.

In some implementations, the media manager 126 may initially retrieve all potential media files from the media file repository 114 that may be relevant for a new incident being analyzed, and may thereafter filter the retrieved media files based on a received prediction from the incident estimator 124. In other implementations, the media manager 126 may retrieve only those media files from the media file repository 114 which correspond to the temporal/geographic prediction of the incident estimator 124 for the new incident being analyzed. In any case, based on the relative likelihoods of inclusion of the new incident being analyzed within the various identified temporal/geographic segments, the media manager 126 may sort, order, or otherwise prioritize individual retrieved media files in a manner corresponding to the predictions of the incident estimator 124. In this way, as described, the media manager 126 may proceed, perhaps in conjunction with the view generator 128, to play or otherwise render individual media files within the prioritized media files 108, and in a manner which facilitates fast, efficient, and convenient review by the user of the system 100.

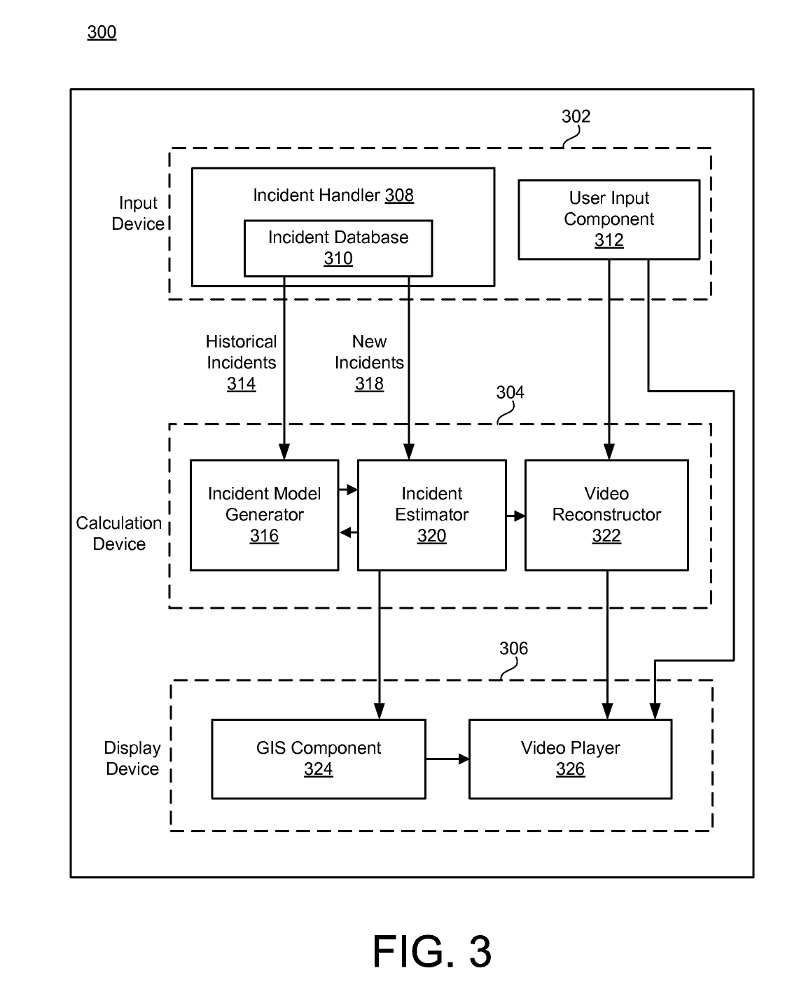

FIG. 3 is a block diagram of a system 300 illustrating an architecture of an example implementation of the incident search facilitator 102 of the system 100 of FIG. 1. FIG. 4 is a simplified map 400 illustrating an example geographical area corresponding to the geographical area 104 of FIG. 1, and described for the sake of example with respect to the system 300 of FIG. 3.

The examples of FIGS. 3 and 4 are illustrated, and described below, with respect to example scenarios for implementation of the system 100 of FIG. 1. Specifically, the examples of FIGS. 3 and 4 are utilized to describe scenarios for analyzing a criminal incident in which a time and location of the criminal incident are not precisely known. As described above, the examples of FIGS. 3 and 4 may be utilized to correlate temporal and geographic probabilities, according to historical incident data, and determine a probability of occurrence for specific geographical zones, routes, or segments, within specific time segments.

In the examples, results of this probabilistic analysis may be used to reconstruct video recordings from criminal surveillance systems, in order to support fast retrieval of related video snippets. Consequently, the examples of FIGS. 3 and 4 illustrate techniques for assisting public police or other security departments in solving criminal cases in which an exact time and/or location of occurrence are not known with sufficient precision. In the specific examples provided below, the example of a pocket-picking, or pickpocket, crime that occurs in public streets (or in public transportation systems, as described and illustrated with respect to FIG. 5) are illustrated and described. Of course, from the above discussion of FIGS. 1 and 2, it will be appreciated that such examples are non-limiting, and that the system 100 of FIG. 1 and the system 300 of FIG. 3 may be used to solve many other types of criminal cases, including criminal incidents in which a location of the crime is known with sufficient or exact precision while the time of occurrence is not known with sufficient precision (e.g., residential or automobile burglaries).

By way of introduction and background to the following, more specific examples, it is well known that police and other security departments often spend significant amounts of time and resources on solving reported incidents, e.g., locating and identifying a suspected thief. For example, as referenced, a police officer may be required to watch a large number of video snippets from a surveillance system in response to a report of a pickpocket incident, because the victim in such cases typically does not know exactly when or where his/her belongings were stolen. That is, a victim may typically only know the last time the stolen belongings were seen, and the time at which the stolen belongings were noticed as having been stolen. In the present description, as referenced above with respect to FIG. 2, such a time window may be referred to as an occurrence time window. For example, if a victim last noticed possession of his wallet at 10:00 a.m., and noticed that the wallet had been stolen at 11:30 a.m., then the occurrence time window in that example would be the one and one-half hours between 10:00 a.m. and 11:30 a.m.

Similarly, as also described above with respect to FIG. 2, an occurrence area may refer to a geographical zone, route, segment, or other identified geographical sub-area representing a spatial area traversed by, in the examples, the pickpocket victim, where the victim last noticed possession of stolen goods prior to entering the occurrence area, and noticed theft of the stolen belongings at the end of the occurrence area. For example, if the victim noticed possession of a stolen wallet upon departing a building, and noticed theft of the wallet upon entering a second building, then the occurrence area would be defined as the route/distance traversed by the victim in walking between the first building and the second building.

As described, the occurrence time window and the occurrence area of a particular incident may both be relatively large. Further, a number of deployed cameras deployed in the geographical area and positioned to observe the occurrence area may also be relatively large. Consequently, the resulting video files that may need to be reviewed by the police or other security department may be large, and difficult to review.

In the example of FIG. 3, the system 300 is illustrated as including three devices, an input device 302, a calculation device 304, and a display device 306. The input device 302 may generally be utilized for collecting historical incident data, as illustrated by an incident handler 308 and an incident database 310, generally corresponding to the incident handler 110 and the incident repository 112, respectively, of FIG. 1. Also in the input device 302, a user input component 312 may be configured to interact with the user of the system 300. For example, the user input component 312 may allow the user to make priority adjustments to prioritized video files (corresponding to the prioritized media files 108 of FIG. 1) that will ultimately be provided by the system 300, as described in more detail below. The user input component 312 may also be utilized to provide the user of the system 300 with options for video filtering, video playback control, and other user interactions with the system 300. As shown, the incident handler 308 may forward, from the incident database 310, historical incidents 314 to an incident model generator 316, corresponding generally to the incident model generator 116 of FIG. 1. As described in detail with respect to FIG. 1, the incident model generator 316 may be configured to request the historical incident data 314 from the incident database 310, including, but not limited to, incident type, location, and time. The incident model generator 316 may then generate a mathematical model based on the retrieved historical incident data.

Then, new incidents 318 reported from the incident database 310, as received and stored by the incident handler 308, may be received by an incident estimator 320, corresponding generally to the incident estimator 124 of FIG. 1. Upon receipt, the incident estimator 320 determines a type and other characteristics of the received incident, and retrieves an appropriate, corresponding incident model from the incident model generator 316. Based thereon, the incident estimator 320 predicts temporal and geographical probability distributions characterizing likelihoods of occurrence of the received incident. In this way, actionable information may be determined for both a time and location of the incident, with a greater level of precision then would ordinarily be available.

Based on the predictions and other estimations of the incident estimator 320, a video reconstructer 322 may be configured to relate the corresponding probability distributions with actual video files that may contain recordings of the incident in question. For example, the incident estimator 320 may estimate a 70% likelihood that the new incident occurred between 10 and 10:30 along a 100 yard distance of a particular street, and a 30% likelihood of occurrence between 10:30 and 11 and within a 100 yard distance of a second street. Then, as described above with respect to the media manager 126 of FIG. 1, the video reconstructer 322 may be configured to correlate the predicted/estimated time/locations with corresponding cameras providing coverage therefore, within the relevant time segments.

As also referenced, the video reconstructer 322 may make such correlations using a number of techniques. For example, the video reconstructer 322 may simply receive user input, by way of the user input component 312, which relates the identified time/locations with appropriate cameras and associated media files, based at least in part on human knowledge of the user of the system 300. In other examples, information regarding a relationship of deployed cameras and geographical coverage areas may be included within, or in conjunction with, the historical incident data records. For example, for historical incident records captured by a particular camera, a camera identifier may be included therein. In additional or alternative implementations, the video reconstructer 322 may include, or have access to, a database or other repository that stores layout information for cameras within the relevant geographical area. Using these or related techniques, the video reconstructer 322 may proceed to identify individual video files (e.g., video snippets), and may order the identified video files in accordance with the temporal/geographic probability distributions provided by the incident estimator 320.

At the display device 306 of FIG. 3, a graphical information system (GIS) component 324 represents a component for determining, displaying, and manipulating geographical information. For example, such a GIS component may be utilized to retrieve and display mapping information corresponding to the geographical area in question, including the occurrence area, along with any relevant geographical information. For example, such geographic information may include latitude/longitude/altitude information, relevant distances or height, relevant geographic landmarks or characteristics, or any other geographical information that may be useful in analyzing the incident under investigation.

As shown, the GIs component 324 may be configured to retrieve incident estimation information from the incident estimator 320, for use in assisting the user of the system 300 in reviewing prioritized video files. For example, the GIS component 324 may initially be provided with an entire geographical area under investigation (e.g., the entire map of FIG. 4, as described below). Then, upon receipt of incident estimation data from the incident estimator 320, the GIS component 324 may filter the initially-retrieved geographical area to include only the occurrence area identified, or portions thereof. The GIS component 324 may also retrieve more detailed information for the occurrence area and occurrence time window, such as available natural or artificial lighting that existed within the occurrence time window, weather conditions, or other information that may be useful in reviewing and investigating the incident under investigation.

Finally in FIG. 3, a video player 326 may be configured to receive the identified, prioritized files from the video reconstructer 322. The video player 326 also may receive geographical information from the GIS component 324. For example, based on the incident estimation data received from the incident estimator 320, the GIS component 324 may visualize probability distributions calculated by the incident estimator 320 on a map, so that the video player 326 may display the corresponding probability distributions on a map displayed to the user of the system 300, in order assist the user in visualizing the probabilities and context of the specific, relevant map.

As also illustrated, the video player 326 may receive input from the user input component 312. For example, the user of the system 300 may be provided, as referenced above, with an ability to alter or supplement an order of the prioritized media files to be played by the video player 326. For example, in some scenarios, the user of the system 300 may have additional knowledge regarding, e.g., the occurrence area and/or the incident being investigated, where such additional knowledge may enable the user to assign a greater or lesser priority to one or more of the prioritized video files then was calculated by the calculation device 304.

For example, the video player 326 may initially display individual (or groups of) prioritized media files. The user may then be able to observe the video files, perhaps in conjunction with the visualized probability distributions and associated mapping information obtained from the GIS component 324. Then, for example, if the user knows that a particular suspected thief has a pattern of operating along a certain street segment, then the user may be allowed to assign the higher probability to video files corresponding to that street segment than was calculated by the calculation device 304. Conversely, of course, if the user has information which makes occurrence of the incident less likely within a given time segment or street segment, then corresponding ones of the prioritized video files may be prioritized lower than their calculated values.

As referenced above, FIG. 4 illustrates a map 400 showing a simplified example of the geographical area 104 of FIG. 1. In the example of FIG. 4, the vertical streets labeled A, B, C, D are numbered 402, 404, 406, and 408, respectively. Meanwhile, horizontal streets labeled 1, 2, 3 are numbered 410, 412, and 414, respectively. In the illustrated example, a time of 10:00 a.m. is numbered 416, and, as referenced above, represents a “from time” which was the last time (and associated location) that a victim can verify possession of stolen belongings. Meanwhile, a time 10:30 a.m. is numbered 418, and represents a time (and associated location) at which the victim became aware of a theft of the belonging in question, also referred to as a “to time.” In other words, the victim last noticed possession at 10:00 a.m. (416), at an intersection of street A 402 and street 1 410, and noticed that theft had occurred at 10:30 a.m. (418), at an intersection of street D 408 and street 3 414. In FIG. 4, the patch between points 416, 418 is indicated by the weighted line.

Table 1 is an example of historical incident data that may be stored in the incident repository 112, e.g., the incident database 310 of FIG. 3. As shown in Table 1, 5 incidents are identified by corresponding incident IDs 0001-0005. As also shown, each incident corresponds in type (i.e., pocket-picking) to a presumed type of incident that has occurred in the example of FIG. 4. As further shown in Table 1, each incident is stored together with a corresponding “from time,” and “to time.”

TABLE 1

| Incident Type | Incident ID | From Time | To Time |
|---|---|---|---|
| pocket-picking | 0001 | 10:00 AM | 01:00 PM |
| pocket-picking | 0002 | 11:00 AM | 12:00 PM |
| pocket-picking | 0003 | 11:30 AM | 12:30 PM |
| pocket-picking | 0004 | 10:30 AM | 01:00 PM |
| pocket-picking | 0005 | 11:30 AM | 12:00 PM |

To perform temporal analysis, such as may be performed by the temporal analyzer 118 of the incident model generator 116 of FIG. 1, a length of a search period may be defined for each occurrence time window defined by each pair of from time/to time data points. That is, the term search period is used below, e.g., in the example of Table 2, and should be understood generally to refer to a time segment, time interval, or other sub-portion of an occurrence time window being considered.

Specifically, for example, as shown in Table 2, such a search period may be set to a value of 30 minutes. Consequently, for the first incident ID 0001, there will be 6 total search periods, because 6 30-minute search periods are included within the 3 hour time window of incident 0001. Consequently, each search period is assigned a weight of ⅙. Using the same technique, a probabilistic weight is assigned to each search period for all 5 of the incidents of Table 1, as illustrated in Table 2, below:

TABLE 2

| Search | | |
|---|---|---|
| Period | Time | Weight |
| Search Period 1 | 10:00 AM~10:30 AM | ⅙ |
| Search Period 2 | 10:30 AM~11:00 AM | ⅙ + ⅕ |
| Search Period 3 | 11:00 AM~11:30 AM | ⅙ + ½ + ⅕ |
| Search Period 4 | 11:30 AM~12:00 PM | ⅙ + ½ + ½ + ⅕ + 1 |
| Search Period 5 | 12:00 PM~12:30 PM | ⅙ + ½ + ⅕ |
| Search Period 6 | 12:30 AM~01:00 PM | ⅙ + ⅕ |

Thus, as shown in Table 2, the second search period, between 10:30 a.m. and 11:00 a.m., occurs twice, i.e., occurs within two incidents in Table 1, because that time period occurs within both incident 0001 and 0004. Since the incident 0004 includes 5 half hour time segments between the “from time” of 10:30 a.m. and the “to time” of 1:00 p.m., a probabilistic weight of ⅕ is added to the ⅙ weight already calculated for search period one.

Similarly, the third search period of 11:00 a.m. to 11:30 a.m. occurs within incidents 0001, 0002, and 0004. The probabilistic weight for this search period within the incident 0002 is ½, since two search periods of 30 minutes are included between the “from time” of 11:00 a.m. and the “to time” of 12:00 p.m. for the incident 0002. Similar comments and analysis would apply for determining the various weights of the remaining search periods 4, 5, and 6.

As illustrated and described below with respect to Table 3 and Table 4, a similar location analysis may be performed, in which the from time and to time are replaced with “from point,” and “to point,” which indicate, respectively, a final location at which the victim was aware of his/her stolen belongings, and the first location that he/she found that the belongings were stolen (so that the intervening area or route represents an occurrence area for the incident in question). Similarly, the search periods of Table 2 can be replaced with geographical intervals, or geo intervals, and a data field “path” (or movement path, or route) can be utilized to assign each geo interval a weight.

For example, as shown in Table 3, it is assumed that 3 incidents of the incident type pocket-picking are included in the historical incident database, having incident IDs 0001, 0002, and 0003, where each incident is stored together with an associated path representing street segments from the example of FIG. 4 which are a subset of, or overlap, a path taken by the victim between points 416/418 in that example.

TABLE 3

| Incident Type | Incident ID | Path |
|---|---|---|
| pocket-picking | 0006 | 1A->1C->3C |
| pocket-picking | 0007 | 1A->1B->3B |
| pocket-picking | 0008 | 1B->3B |

Thus, Table 3 corresponds conceptually to Table 1 in providing an example of data from the historical incident database, illustrating location data rather than temporal data. Similarly, Table 4, like Table 2, illustrates an assignment of probabilistic weight for each geo interval contained within each of the 3 paths of Table 3, just as Table 4 provided probabilistic weight for each search period contained within the 5 incidents of Table 1 and associated occurrence time windows.

TABLE 4

| Geo-Interval | Street Segmentation | Weight |
|---|---|---|
| Geo-Interval 1 | [1A, 1B] | ¼ + ⅓ |
| Geo-Interval 2 | [1B, 1C] | ¼ |
| Geo-Interval 3 | [1B, 2B] | ⅓ + ½ |
| Geo-Interval 4 | [2B, 3B] | ⅓ + ½ |
| Geo-Interval 5 | [1C, 2C] | ¼ |
| Geo-Interval 6 | [2C, 3C] | ¼ |

As shown above in Table 4, 6 geo intervals are defined based on street segments from FIG. 4. For example, geo interval 1 is defined with respect to a street segmentation of [1A,1B]. As may be observed from Table 3, this street segmentation is included within the path 1A->1C->3C of incident 0001 (i.e., the street segmentation [1A,1B] is a segment included within the path portion 1A->1C of the incident 0001. Similarly, the same street segmentation [1A,1B] is included within the path 1A->1B->3B of incident 0002.

Then, assuming that each street segmentation is defined as existing between intersections in FIG. 4, a probabilistic weight may be assigned to each occurrence of the geo interval 1 within each of the incidents 0001 and 0002, just as a probabilistic weight was added for each search period/time segment of each occurrence time window of Table 1, in the example of Table 2. Thus, because 4 street segmentations are included within the path of the incident 0001, the street segmentation [1A,1B] is assigned a probabilistic weight of ¼ for the occurrence thereof and the path of the incident 0001. Similarly, the street segmentation [1A,1B] occurs in one of the street segmentations of the path of the incident ID 0002, and is therefore assigned a probabilistic weight of ⅓ for the geo interval 1. Similarly, probabilistic weight may be added to the weight field of Table 4 for each of the remaining geo intervals 2-6.

As will be appreciated from the above description, Tables 1-4 represent historical data and associated analysis thereof that is utilized and/or calculated by the incident model generator 116 of FIG. 1. That is, for example, the temporal analyzer 118 may be utilized to calculate Table 2, while the location analyzer 120 may be utilized to calculate Table 4. Then, the incident model generator 116 may be configured to store data of Table 2 and 4, perhaps combined or linked with one another, to obtain a corresponding incident model to be stored within the incident model repository 122. Of course, similar comments would apply with respect to the incident model generator 316 of calculation device 304 of FIG. 3.

It may thus be appreciated that a combination of data corresponding to the types of data stored using Tables 2 and 4 can be included in, or used to form, the corresponding incident model. In some implementations, the time and/or geo probabilities (e.g., probabilistic weights) may be calculated (or re-calculated) in response to a receipt of a new incident. In additional or alternative implementations, for example, weights may be pre-calculated using pre-defined time segments and geo-intervals, so that, when the new incident is received, new probabilities may be calculated using the pre-calculated weights.

The resulting incident model may be utilized to analyze the new incident illustrated in FIG. 4 with respect to times 416/418. Specifically, as shown below in the examples of Tables 5 and 6, it is assumed that 5 equal-distance geo intervals may be defined with respect to corresponding street segments of the map of FIG. 4, and the number of geo intervals may be the same in number as a number of selected search periods.

That is, in the examples of Table 1 and 2, 5 incidents are included, because that is the number of incidents that happened to be included within the historical incident database, and the length of a search period is set somewhere arbitrarily to provide equal amounts of times within each search period/time segment of each overall occurrence time window. Similarly, the 3 incidents of Table 3 are included as those incidents that happened to be included within the historical incident database for the incident type under investigation, and that include relevant paths and associated geo intervals. The various incidents of tables of the types of Table 1 and Table 3 need not, but may, include the same or overlapping incidents.

In contrast, as referenced above, when calculating probable distributions for the newly-received incident being investigated, it is possible to make reasonable assumptions relating time segments/search periods of an overall occurrence time window and geo intervals of an overall occurrence area. For example, it may be assumed that, in the absence of information to the contrary, the victim walked at a constant speed throughout the occurrence time window in question. With such an assumption, a length of search period for each geo interval may be calculated, and a weight may be calculated for each geo interval and each search period, using the techniques described above with respect to Tables 1-4, and resulting in the examples of Tables 5 and 6:

TABLE 5

| | Street | | |
|---|---|---|---|
| Geo-Interval | Segmentation | Weight | Probability |
| Geo-Interval 1 | [1A, 1B] | ⅓ | 0.1249 |
| Geo-Interval 2 | [1B, 2B] | ¼ | 0.1071 |
| Geo-Interval 3 | [2B, 2C] | ½ | 0.2143 |
| Geo-Interval 4 | [2C, 3C] | 1 | 0.4286 |
| Geo-Interval 5 | [3C, 3D] | ¼ | 0.1071 |

TABLE 6

| Search | | | |
|---|---|---|---|
| Period | Time | Weight | Probability |
| Search Period 1 | 10:00 AM~10:06 AM | ⅓ | 0.1176 |
| Search Period 2 | 10:06 AM~10:12 AM | ⅔ | 0.2353 |
| Search Period 3 | 10:12 AM~10:18 AM | 1 | 0.3529 |
| Search Period 4 | 10:18 AM~10:24 AM | ⅓ | 0.1176 |
| Search Period 5 | 10:24 AM~10:30 AM | ½ | 0.1765 |

To calculate the probability values for Tables 5 and 6, the following techniques may be used. Specifically, Equation 1 calculates the probability that the incident happened in a t-th time period:

$${P}_{t} = \frac{{w}_{t}}{{\sum }_{i = 0}^{m} {w}_{t}} \qquad Equation 1$$

Where the wₜ is the weight of the t-th time period, and

$${P}_{t} = \frac{{w}_{t}}{{\sum }_{i = 0}^{m} {w}_{t}}$$

is the sum of all of the weights in Table 6. A probability of location may be calculated in the same way.

In order to utilize Tables 5 and 6 to perform video construction and select the prioritized media files of FIG. 1, the various location and temporal probabilities may be combined. For example, the location and temporal probabilities may each be multiplied. For example, the probability of search period one is 0.1176 and the probability of geo interval one is 0.1249, so that the multiplied score=0.01469. In other words, the resulting score implies that, according to historical incident data, a probability that the incident happened during search period one at geo interval one is 0.01469.

If a similar score is calculated for all the combinations of search periods and geo intervals, then the resulting scores may be sorted in descending order. Consequently, an incident probability at each combination of time and geo interval may be determined, so that the total number of combinations will equal a number of search periods multiplied by the number of geo intervals.

In practice, as referenced above with respect to Tables 2 and 4, the time and/or geo probabilities (e.g., probabilistic weights) may be calculated (or re-calculated) in response to a receipt of the new incident, or, weights may be pre-calculated using pre-defined time segments and geo-intervals, so that, when the new incident is received, new probabilities may be calculated using the pre-calculated weights. Thus, in the simplified example(s) of Tables 5 and 6, since different time segments are used for the new incident, corresponding weights would have to be calculated. Also, it will be appreciated that, in calculating the simplified example of Table 6, the historical data listed in Table 1 would not be sufficient, since only one incident happened between 10:00 AM and 10:30 AM. Of course, in practice, the historical database would be significantly larger than in the simplified examples listed in Table 1 (that is, it may be assumed that there were many incidents that happened between 10:00 AM and 10:30 AM, and Table 6 can be calculated using these). Consequently, the illustrated weights (e.g. “⅓”) in Table 6 are intended merely as representations of the types of weights that would be calculated if such a larger quantity of incident data were available.

As an optimization, it may be observed that some such combinations are inherently less likely than others. For example, it is unlikely that the victim was at an early geo interval at a later time segment, or conversely, was at a later geo interval at an early time segment. Therefore, it is possible to apply a penalty to certain combinations, reflecting these observations.

For example, to apply penalty to each combination, a penalized score for a given combination may be assigned by first taking an absolute value of a difference between a search period number and a geo interval number of a given combination. For example, for the combination of search period one and geo interval five, the absolute difference would be four. The result may be added to the number 1, in order to avoid a 0 value for a denominator when dividing an original score with a combination in question, to thereby obtain the penalized score for the combination in question.

Thus, the penalized score may be obtained by equation 2, using the just-referenced techniques:

Penalized Score=Unpenalized Score/(|t−k|+1) Equation 2

In other words, a penalty applied to a particular combination score will be greater for greater differences between a number of the search period of the combination and a number of the geo interval of the combination. Of course, different assumptions may impact these types of calculations. For example, a knowledge that the victim was moving at different speeds within different intervals, or that the victim stopped moving for a time while traversing one of the intervals. In these cases, corresponding adjustments to the penalty calculations may be advantageous.

Thus, based on the resulting ordered combinations, using the above scores, associated penalties, and any associated user input, the related video files may be played in order. For example, if search period 4 multiplied by geo interval 3 has the highest (penalized) score and there is no user input, then the video captured by a camera at geo interval 3 beginning at a beginning time of search period 4 will be played first for the user of the systems FIGS. 1/3.

Of course, as already described, FIG. 4 represents a simplified, non-limiting example, and FIG. 5 illustrates a related example, in which the geographical area includes a subway network. In the example of the subway map 500 of FIG. 5, a first subway line 502, a second subway line 504, and a third subway line 506, and a fourth subway line 508 are illustrated. A station A at 9:00 a.m. is indicated by reference numeral 510 as illustrating a beginning of an occurrence area and associated occurrence time window. A station B at 9:25 a.m. is marked by reference numeral 512 and indicates an end of the associated occurrence area and occurrence time window. In FIG. 5, the patch between points 510, 512 is indicated by the weighted line. Thus, the same type of analysis provided for FIG. 4 may easily be applied to the example of FIG. 5, and to many other example implementations.

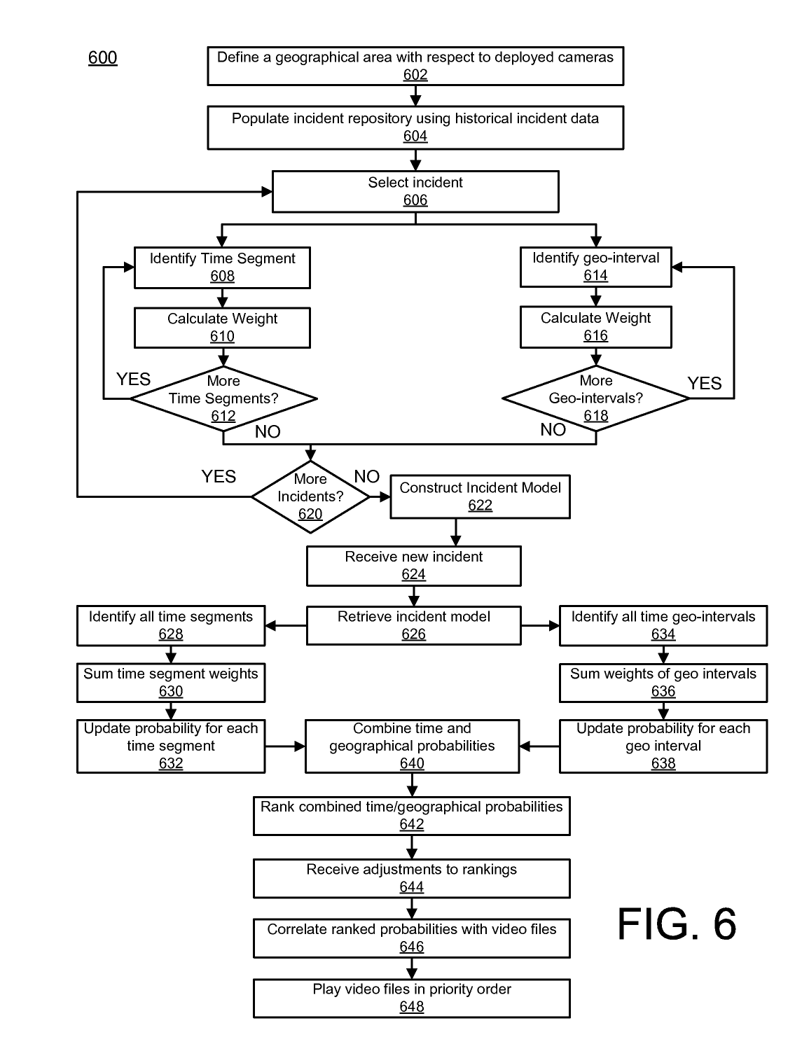

FIG. 6 is a flowchart 600 illustrating more detailed operations of the system 300 of FIG. 3. In the example of FIG. 6, a geographical area may be defined with respect to deployed cameras (602), such as the geographical areas 400, 500 of FIGS. 4, 5. An associated incident repository may be populated, using historical incident data (604).

In order to construct a corresponding incident model, a first such incident may be selected from the historical incident database repository (606). Time segments for the identified/selected incident may be identified (608). A corresponding weight for each time segment may be calculated (610), as described above. If more time segments remain (612), then they may be identified (608), and associated weights calculated (610). Also for each incident, each included geo interval may be identified (614), and its associated weight may be calculated (616), as long as additional geo intervals are included within the incident being investigated (618).

Once all time segments and associated geo intervals have been processed (612, 618), then, if additional incidents remain (620), operation 606-618 may continue. Once all incidents have been analyzed, the corresponding incident model may be constructed (622). As illustrated, the weight calculations for time segments and geo intervals may be performed in parallel.

When a new incident is received (624), then the corresponding incident model may be retrieved (626). That is, as described above, for example, an incident model for a particular, relevant incident type may be retrieved. Then, again operating in parallel in the example of FIG. 6, all time segments of the new incident may be identified (628) and time segment weights for corresponding time segments may be calculated in sum (630). Then, a probability for each time segment may be updated, where, as described above with respect to equations 1 and 2, the updated probability is generally equal to a weight of each search period divided by a sum of the weights of all the time segments.

Similarly, all geo intervals for the retrieved new incident may be identified (634), and weights of each of the geo intervals may be calculated and summed (636). The updated probability for each geo interval may be calculated (638), where, again, the probability is generally equal to a weight of each geo interval divided by the sum of all the weights of the geo intervals.

In this way, a combination of the time and geographical probabilities may be obtained (640). The resulting combined time geographical probabilities may be ranked (642), perhaps incorporating types of penalty adjustments described above. Any additional user adjustments to the rankings may be received (644), and the ranked probabilities may then be correlated with corresponding video files (646). Finally, the thus-retrieved video files may be played back in a corresponding priority order (648).

Pseudo code 1 provides example pseudo code for implementing the techniques of FIG. 6, in conjunction with the above description of FIGS. 1-5. In the terminology of FIG. 6, the term ‘search period’ is used interchangeably with the terminology of ‘time segment’ used above (e.g., in FIG. 6), referencing the use of individual time segments as periods to be searched when attempting to locate a desired incident, as described above, e.g., with respect to Table 1.

Pseudo Code 1

```
    ## The following pseudo code defines two data structures relating to search period
and geo-interval
    ## No overlapping search periods and gen-intervals in the system
    ##
    ## SearchPeriod {
    ## from_time; // data field - time stamp
    ## to_time; // data field - time stamp
    ## weight; // data field - a float number
    ## probability; // data field - a float number between 0 and 1
    ## }
    ##
    ## GeoInterval {
    ## from_position; // data field - longitude and latitude or a geographic label
    ## to_position; // data field - longitude and latitude or a geographic label
    ## weight; // data field - a float number
    ## probability; // data field - a float number between 0 and 1
    ## }
    ##
    ## Weight Calculation
    ##
    ## for each incident in the historical database
    ## find corresponding search periods that cover the from and to time of this
incident
    ## for each corresponding search period
    ## update weight: weight = weight + 1/the number of corresponding
search periods
    ## end for each
    ## end for each
    ##
    ## for each incident in the historical database
    ## find corresponding geo-intervals that cover the path of this incident
    ## for each corresponding geo-interval
    ## update weight: weight = weight + 1/the number of corresponding
geo-intervals
    ## end for each
    ## end for each
    ##
    ## Probability Calculation
    ##
    ## get all the search periods of the new incident
    ## sum up the weight of those search periods
    ## for each search period
    ## update probability: probability = weight of this search period/ the sum of
weights
    ## end for each
    ##
    ## get all the geo-intervals of the new incident
    ## sum up the weight of those geo-intervals
    ## for each geo-interval
    ## update probability: probability = weight of this geo-interval / the sum of
weights
    ## end for each
    ##
```

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one processor to:
receive a plurality of incident reports, each incident report characterizing an incident occurring within a geographical area;
generate an incident model, based on, for each incident, an occurrence time window and an occurrence area within the geographical area;
receive a new incident report characterizing a new incident occurring within the geographical area and recorded within a plurality of media files captured by at least one media capture device; and
prioritize the plurality of media files, based on the incident model, in an order corresponding to a likelihood of inclusion of the new incident therein.

2. The computer program product of claim 1, wherein the instructions, when executed, are configured to cause the at least one processor to:
receive, categorize, and store the plurality of incident reports according to an associated incident type for each incident report.

3. The computer program product of claim 1, wherein the occurrence time window is defined as existing between a time from which a corresponding incident first may have happened, and a time at which the incident was ascertained to have actually happened.

4. The computer program product of claim 3, wherein, in the incident model, occurrence time windows for each historical incident are divided into time segments, and a weight is assigned to each time segment based on its inclusion in one or more of the occurrence time windows.

5. The computer program product of claim 1, wherein the occurrence area is defined as a portion of the geographic area including a route over which a moving object moved to travel from a start point to an end point of the occurrence area.

6. The computer program product of claim 5, wherein, in the incident model, occurrence areas for each historical incident are divided into geo-intervals, and a weight is assigned to each geo-interval based on its inclusion in one or more of the occurrence areas.

7. The computer program product of claim 6, wherein the occurrence area includes a route along one or more streets, and the geo-intervals include street segments of the one or more streets.

8. The computer program product of claim 1, wherein the instructions, when executed, are configured to cause the at least one processor to:
retrieve the incident model from among a plurality of incident models, based on a new occurrence time of the new incident and on a new occurrence area for the new incident.

9. The computer program product of claim 8, wherein the instructions, when executed, are configured to cause the at least one processor to:
retrieve the incident model based on a correspondence of incident type between a type of the incident model and a type of the new incident.

10. The computer program product of claim 1, wherein the instructions, when executed, are configured to cause the at least one processor to:
update the incident model based on the new incident, including adding a new occurrence time window and new occurrence area; and
select incident reports from the incident model, based on the new occurrence time window and the new occurrence area.

11. The computer program product of claim 10, wherein the instructions, when executed, are configured to cause the at least one processor to:
divide the new occurrence time window into time segments and assign a weight to each time segment based on its inclusion in one or more of the occurrence time windows and the new occurrence time window;
divide the new occurrence are into geo-intervals and assign a weight to each geo-interval based on its inclusion in one or more of the occurrence areas and the new occurrence areas.

12. The computer program product of claim 11, wherein the instructions, when executed, are configured to cause the at least one processor to:
assign probabilities to each of the time segments, based on the weight assigned to each time segment;
assign probabilities to each of the geo intervals, based on the weight assigned to each geo-interval.

13. The computer program product of claim 12, wherein the instructions, when executed, are configured to cause the at least one processor to:
combine the probabilities assigned to each of the geo intervals with the probabilities assigned to each of the time segments to thereby obtain probabilities that the new incident was recorded at corresponding times and geo-intervals by the at least one media capture device; and
prioritize the plurality of media files, based on the combined probabilities.

14. A computer-implemented method for executing instructions stored on a non-transitory computer readable storage medium, the method comprising:
receiving a plurality of incident reports, each incident report characterizing an incident occurring within a geographical area;
generating an incident model, based on, for each incident, an occurrence time window and an occurrence area within the geographical area, wherein the occurrence time window is defined as existing between a time from which a corresponding incident first may have happened, and a time at which the incident was ascertained to have actually happened, and wherein the occurrence area is defined as a portion of the geographic area including a route over which a moving object moved to travel from a start point to an end point of the occurrence area;
receiving a new incident report characterizing a new incident occurring within the geographical area and recorded within a plurality of media files captured by at least one media capture device, the new incident report including a new occurrence time window and new occurrence area; and
prioritizing the plurality of media files, based on the incident model, the new occurrence time window, and the new occurrence area, in an order corresponding to a likelihood of inclusion of the new incident therein.

15. The method of claim 14, wherein,
in the incident model, occurrence time windows for each historical incident are divided into time segments, and a weight is assigned to each time segment based on its inclusion in one or more of the occurrence time windows, and
in the incident model, occurrence areas for each historical incident are divided into geo-intervals, and a weight is assigned to each geo-interval based on its inclusion in one or more of the occurrence areas.

16. The method of claim 14, comprising:
dividing the new occurrence time window into time segments;
assigning a weight to each time segment based on its inclusion in one or more of the occurrence time windows and the new occurrence time window;
dividing the new occurrence area into geo-intervals; and
assigning a weight to each geo-interval based on its inclusion in one or more of the occurrence areas and the new occurrence areas.

17. The method of claim 16, comprising:
assigning probabilities to each of the time segments, based on the weight assigned to each time segment;
assigning probabilities to each of the geo intervals, based on the weight assigned to each geo-interval;
combining the probabilities assigned to each of the geo intervals with the probabilities assigned to each of the time segments to thereby obtain probabilities that the new incident was recorded at corresponding times and geo-intervals by the at least one media capture device; and
prioritizing the plurality of media files, based on the combined probabilities.

18. A system comprising:
at least one processor; and
instructions recorded on a non-transitory computer-readable medium, and executable by the at least one processor, the system including
an incident handler configured to cause the at least one processor to receive a plurality of incident reports, each incident report characterizing an incident occurring within a geographical area;
an incident model generator configured to cause the at least one processor to generate an incident model, based on, for each incident, an occurrence time window and an occurrence area within the geographical area;
an incident estimator configured to cause the at least one processor to receive a new incident report characterizing a new incident occurring within the geographical area and recorded within a plurality of media files captured by at least one media capture device, the new incident report including a new occurrence time window and new occurrence area, and further configured to cause the at least one processor to prioritize the plurality of media files, based on the incident model, the new occurrence time window, and the new occurrence area, in an order corresponding to a likelihood of inclusion of the new incident therein; and
a media manager configured to cause the at least one processor to select and sort the prioritized media files for ordered playback thereof.

19. The system of claim 18, wherein the incident estimator is further configured to cause the at least one processor to:
divide the new occurrence time window into time segments;
assign a weight to each time segment based on its inclusion in one or more of the occurrence time windows and the new occurrence time window;
divide the new occurrence area into geo-intervals; and
assign a weight to each geo-interval based on its inclusion in one or more of the occurrence areas and the new occurrence areas.

20. The system of claim 18, wherein the incident estimator is further configured to cause the at least one processor to:
assign probabilities to each of the time segments, based on the weight assigned to each time segment;
assign probabilities to each of the geo intervals, based on the weight assigned to each geo-interval;
combine the probabilities assigned to each of the geo intervals with the probabilities assigned to each of the time segments to thereby obtain probabilities that the new incident was recorded at corresponding times and geo-intervals by the at least one media capture device; and
prioritize the plurality of media files, based on the combined probabilities.
